(19) United States
(12) Patent Application Publication
(10) Pub. No.: US 2024/0177516 A1
(43) Pub. Date: May 30, 2024

(54) IMAGE PROCESSING APPARATUS, IMAGE PROCESSING METHOD, AND NON-TRANSITORY COMPUTER-EXECUTABLE MEDIUM

(71) Applicant: PFU LIMITED, Ishikawa (JP)

(72) Inventors: Tomoaki WADA, Ishikawa (JP); Kunihiko OUMI, Ishikawa (JP)

(21) Appl. No.: 18/431,760

(22) Filed: Feb. 2, 2024

Related U.S. Application Data
(63) Continuation of application No. PCT/JP21/29280, filed on Aug. 6, 2021.

(51) Int. Cl. G06V 30/414; G06T 5/77; G06V 30/18

(52) U.S. Cl. CPC G06V 30/414; G06T 5/77; G06V 30/1801; G06T 2207/30176

(57) ABSTRACT

An image processing apparatus includes processing circuitry. The processing circuitry identifies an outer edge of a document with respect to image data optically read from the document and fills an outside from the outer edge in the image data with a predetermined color.

### CROSS-REFERENCE TO RELATED APPLICATION

This patent application is a continuation application of International Application No. PCT/JP2021/029280, having an international filing date of Aug. 6, 2021, the entire disclosure of which is hereby incorporated by reference herein.

### BACKGROUND

### Technical Field

Embodiments of the present disclosure relate to an image processing apparatus, an image processing method, and a non-transitory computer-executable medium.

### Related Art

For example, an image processing apparatus has been proposed, which includes a scan unit that scans an object to be scanned and outputs image data, an edge extraction unit that extracts edges of the image data, a non-edge region detection unit that detects a non-edge region of the image data based on the edges, a temporary determination unit that temporarily determines whether the non-edge region is an image region of the object to be scanned or a background image region based on a predetermined condition, and a correction unit that corrects the temporary determination of the non-edge region based on the arrangement of the temporarily determined non-edge region.

Further, an inspection apparatus has been proposed, which includes an image reading unit that scans a sheet, and a background member that is arranged to face the image reading unit with the sheet sandwiched therebetween and is capable of switching between a plurality of background colors. The inspection apparatus is provided with a color discrimination unit that discriminates color of a corner of the sheet, a background color selection unit that selects, from the plurality of background colors, a background color having a relatively high contrast with respect to the color of the corner of the sheet, and a corner fold detection unit that detects a corner fold of the sheet based on a result of scanning the sheet by the image reading unit using the background member of the selected background color.

Further, an image editing system has been proposed, which includes an image reading means for reading an image of a business form in which characters or figures are described in a specific pattern color on a predetermined background color by decomposing the image into pixels together with a background having a background color different from the background color, a defect searching means for comparing a shape and a dimension of the image of the business form read by the image reading means with business form format information registered in advance and searching whether a defective portion in a peripheral part of the image is present, a defect correction means for correcting the defective portion by supplementing the defective portion with the background color of the business form when a defective portion is present in the image, and a pattern addition means for adding an additional pattern of a predetermined character or figure to a predetermined position of the image of the business form normally read and the image of the business form corrected by the defect correction means.

Furthermore, an image reading apparatus has been proposed, which includes a first light source that irradiates one surface of a document with light, a second light source that irradiates another surface of the document with light, a reading means configured to receive light irradiated from the first light source and reflected by the one surface of the document and read a read image of the document, and to receive light irradiated from the second light source and read a transmission image of the document, and a control means configured to detect a state of the document based on the transmission image.

### SUMMARY

According to an embodiment of the present disclosure, an image processing apparatus includes processing circuitry. The processing circuitry identifies an outer edge of a document with respect to image data optically read from the document; and fills an outside from the outer edge in the image data with a predetermined color.

According to another embodiment of the present disclosure, an image processing method includes identifying and filling. The identifying identifies an outer edge of a document with respect to image data optically read from the document. The filling fills, with a predetermined color, an outside from the outer edge identified by the identifying in the image data.

According to still another embodiment of the present disclosure, a non-transitory computer-executable medium stores a plurality of instructions which, when executed by a processor, causes the processor to perform identifying and filling. The identifying identifies an outer edge of a document with respect to image data optically read from the document. The filling fills, with a predetermined color, an outside of the outer edge identified by the identifying in the image data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image processing system;

FIG. 2A and FIG. 2B are diagrams illustrating a relationship between crop processing of a scan image and document ends;

FIG. 3 is a diagram illustrating an outline of image processing;

FIG. 4 is a diagram illustrating a hardware configuration of an image processing apparatus;

FIG. 5 is a diagram illustrating a functional configuration of the image processing apparatus;

FIG. 6 is a diagram illustrating an outer edge identification unit in more detail;

FIG. 7 is a flowchart of an overall operation of the image processing apparatus;

FIG. 8 is a diagram illustrating a table that associates output destinations of a file and background colors;

FIG. 9A, FIG. 9B, and FIG. 9C are diagrams illustrating processing of an end point identification unit;

FIG. 10 is a diagram illustrating noises at end points identified by the end point identification unit;

FIG. 11A, FIG. 11B, and FIG. 11C are diagrams illustrating processing of a filling unit;

FIG. 12 is a diagram illustrating detection results of document ends and problems thereof;

FIG. 13 is a diagram illustrating an outline of a discriminant analysis method;

FIG. 14 is a diagram illustrating variations of a background region filled by the filling unit;

FIG. 15 is a flowchart illustrating noise correction processing in a linear region;

FIG. 16 is a diagram illustrating a local angle formed by three adjacent end points;

FIG. 17 is a flowchart illustrating noise correction processing in a non-linear region;

FIG. 18 is a diagram illustrating a local gouging;

FIG. 19 is a diagram illustrating a shiny side and a shadow side; and

FIG. 20 is a diagram for comparing a scan image scanned with a white backing with an image filled with a black background color.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described below with reference to the drawings.

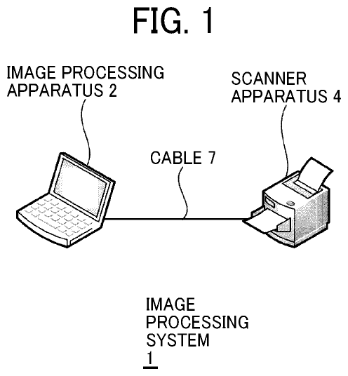

FIG. 1 is a diagram illustrating an overall configuration of an image processing system 1.

As illustrated in FIG. 1, the image processing system 1 includes an image processing apparatus 2 and a scanner apparatus 4, which are connected to each other via a cable 7.

The image processing apparatus 2 is, for example, a computer terminal, and performs image processing on image data received from the scanner apparatus 4.

The scanner apparatus 4 is an image reading apparatus that optically reads image data from a document (image display medium), and, for example, transmits the read image data to the image processing apparatus 2 via the cable 7.

The cable 7 is, for example, a universal serial bus (USB) cable.

In this example, a form in which image data is transmitted from the scanner apparatus 4 to the image processing apparatus 2 via the cable 7 will be described as a specific example, but the present invention is not limited to this, and for example, image data may be transmitted from the scanner apparatus 4 to the image processing apparatus 2 by wireless communication, or the image processing apparatus 2 may be incorporated in the scanner apparatus 4.

In the above configuration, in the general hardware configuration of the scanner apparatus 4, there is a “backing” that is used as an underlay when an image of a passing paper (document) is captured.

This backing has merits and demerits depending on the color of the backing (background color), so the backing often differs depending on the product.

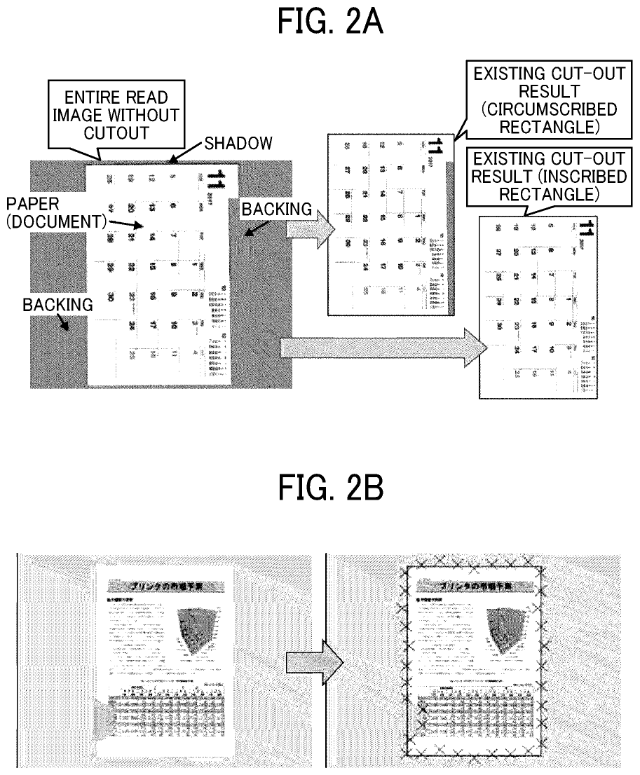

Of course, in a case where a document cutout function (cropping) is used, these differences are not noticeable (in a clear rectangle, the backing portion is not seen), but the operation is not always performed on the premise of the cut out. In this case, the “backing portion” in the read image appears as illustrated in FIG. 2A. That is, the presence of the backing is not always invisible to a user, and there is a case where the “conspicuous degree of the backing” is directly linked to the business.

In the case of reading a white paper on a white backing, in general, the gradation difference between the document and the backing is small, and further, due to factors such as a shadow and shine caused by irradiation of a light source, document edge points (cases are often searched based on the gradation difference) cannot always be accurately identified one by one.

For this reason, as illustrated in FIG. 2B, the cropping is premised on a “rectangle”, and by creating an approximation straight line or an approximation rectangle, “highly accurate rectangle detection” is realized in a pseudo manner.

However, as a function for the scanner apparatus 4, it is not necessarily sufficient to be able to cut out a rectangular shape, and there are demands for cutting out a non-rectangular shape while accurately following a document edge (deletion of a backing portion), detection of folding and chipping, and the like. These functions have been implemented in the limited environment of a white paper document on a black backing, but not in a white paper document on a white backing.

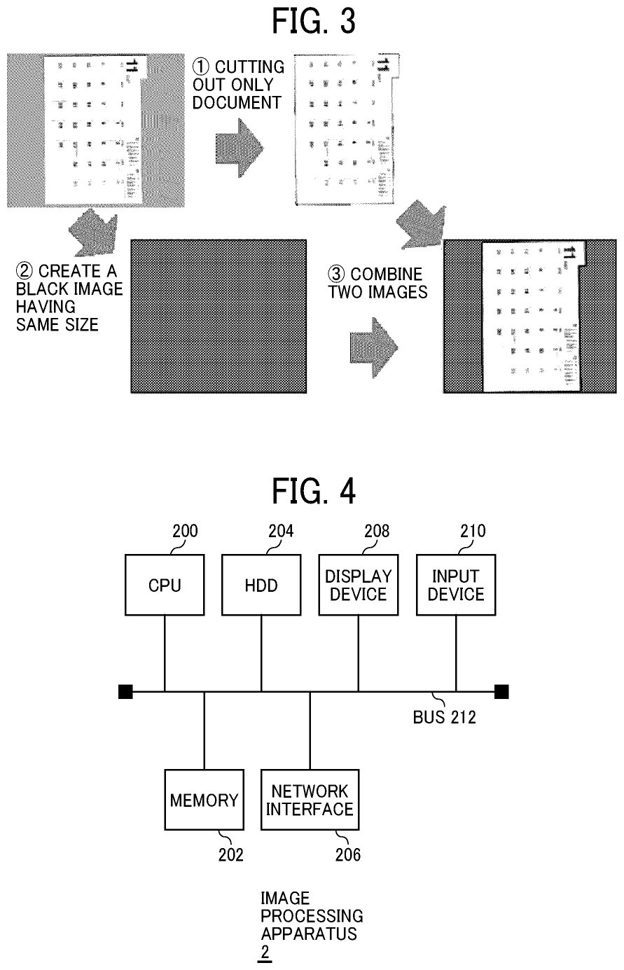

Therefore, in the image processing system 1 of the present embodiment, as illustrated in FIG. 3, the image processing apparatus 2 cuts out only a document region from the image data read by the scanner apparatus 4, creates a background image (black image) having the same size as the image (scan image) read by the scanner apparatus 4, and combines the two images. Thus, even when the scanner apparatus 4 performs scan with a white backing, the image processing apparatus 2 can generate a scan image in which the background region is filled with black.

FIG. 4 is a diagram illustrating a hardware configuration of the image processing apparatus 2.

As illustrated in FIG. 4, the image processing apparatus 2 includes a central processing unit (CPU) 200, a memory 202, a hard disk drive (HDD) 204, a network interface 206 (network IF 206), a display device 208, and an input device 210, which are connected to each other via a bus 212.

The CPU 200 is, for example, a central processing unit.

The memory 202 is, for example, a volatile memory, and functions as a main storage device.

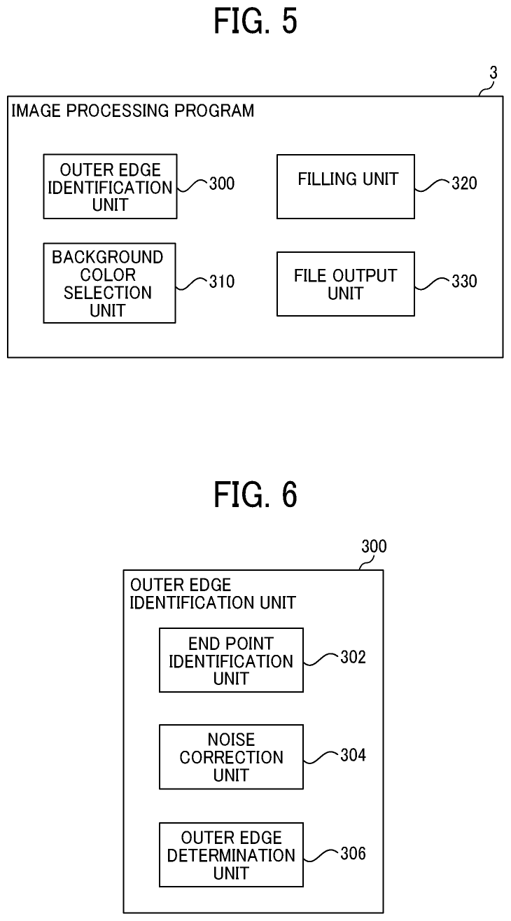

The HDD 204 is, for example, a hard disk drive device, which stores a computer program (e.g., an image processing program 3 in FIG. 5) and other data files as a nonvolatile recording device.

The network IF 206 is an interface for wired or wireless communication, and realizes communication with the scanner apparatus 4, for example.

The display device 208 is, for example, a liquid crystal display.

The input device 210 is, for example, a keyboard and a mouse.

FIG. 5 is a diagram illustrating a functional configuration of the image processing apparatus 2.

As illustrated in FIG. 5, the image processing program 3 is installed and operated in the image processing apparatus 2 of this example. The image processing program 3 is stored in a recording medium such as a compact disc read-only memory (CD-ROM), for example, and is installed in the image processing apparatus 2 via the recording medium.

The image processing program 3 includes an outer edge identification unit 300, a background color selection unit 310, a filling unit 320, and a file output unit 330.

A part or all of the image processing program 3 may be implemented by hardware such as an application specific integrated circuit (ASIC), or may be implemented by borrowing a part of the function of an operating system (OS).

In the image processing program 3, the outer edge identification unit 300 identifies an outer edge of a document with respect to image data optically read from the document by the scanner apparatus 4.

More specifically, as illustrated in FIG. 6, the outer edge identification unit 300 includes an end point identification unit 302, a noise correction unit 304, and an outer edge determination unit 306. The end point identification unit 302 identifies the positions of the end points (document edge points) constituting the document ends based on a gradation change in the image data. The noise correction unit 304 corrects the position of an end point of the document based on other end points existing in the vicinity of the end point with respect to the end points of the document identified by the end point identification unit 302. The outer edge determination unit 306 connects a plurality of end points identified by the end point identification unit 302 (or end points corrected by the noise correction unit 304), and determines the outer edge of the document.

The background color selection unit 310 selects a background color used by the filling unit 320. For example, the background color selection unit 310 selects a color different from the backing of the scanner apparatus 4 as the background color to be used by the filling unit 320. The background color selection unit 310 may also select a color associated with the software that transfers the image data as the background color to be used by the filling unit 320. The background color selection unit 310 of this example selects a background color to be used by the filling unit 320 in accordance with an output destination to which the image data is output by the file output unit 330.

In the image data read by the scanner apparatus 4, the filling unit 320 fills an outside from the outer edge identified by the outer edge identification unit 300 with a predetermined color. For example, in the image data read by the scanner apparatus 4, the filling unit 320 fills the outside from the outer edge identified by the outer edge identification unit 300 with the color selected by the background color selection unit 310. The filling unit 320 of this example cuts out only the document region from the scan image according to the outer edge of the document identified by the outer edge identification unit 300, creates a background image (an image filled with the color selected by the background color selection unit 310) having the same size as the scan image, and superimposes the image of the cut-out document region on the background image.

The file output unit 330 outputs, to a predetermined output destination, image data in which the outside from the outer edge is filled with a predetermined color by the filling unit 320. For example, the file output unit 330 outputs the image data in which the outside from the outer edge is filled with a predetermined color by the filling unit 320 to other image processing software (image processing application) in the image processing apparatus 2 or an external web service.

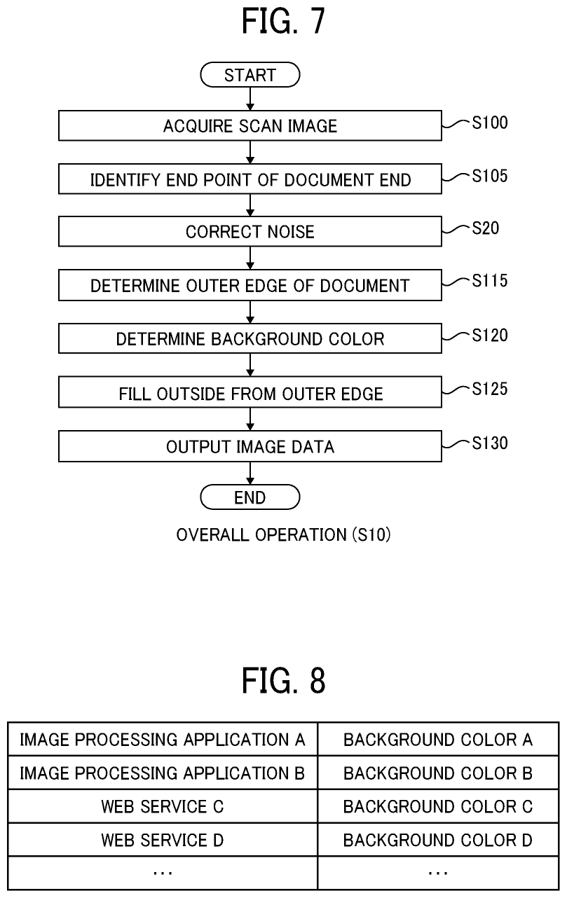

FIG. 7 is a flowchart for explaining the overall operation (S10) of the image processing apparatus 2.

As illustrated in FIG. 7, in step 100 (S100), the image processing program 3 (FIG. 5) of the image processing apparatus 2 acquires the image data (scan image) read by the scanner apparatus 4.

In step 105 (S105), the end point identification unit 302 (FIG. 6) of the image processing program 3 searches, from the outer side of the acquired scan image, for a point where the gradation change is equal to or greater than a reference value or the color change is equal to or greater than a reference value, and identifies the end point of the document.

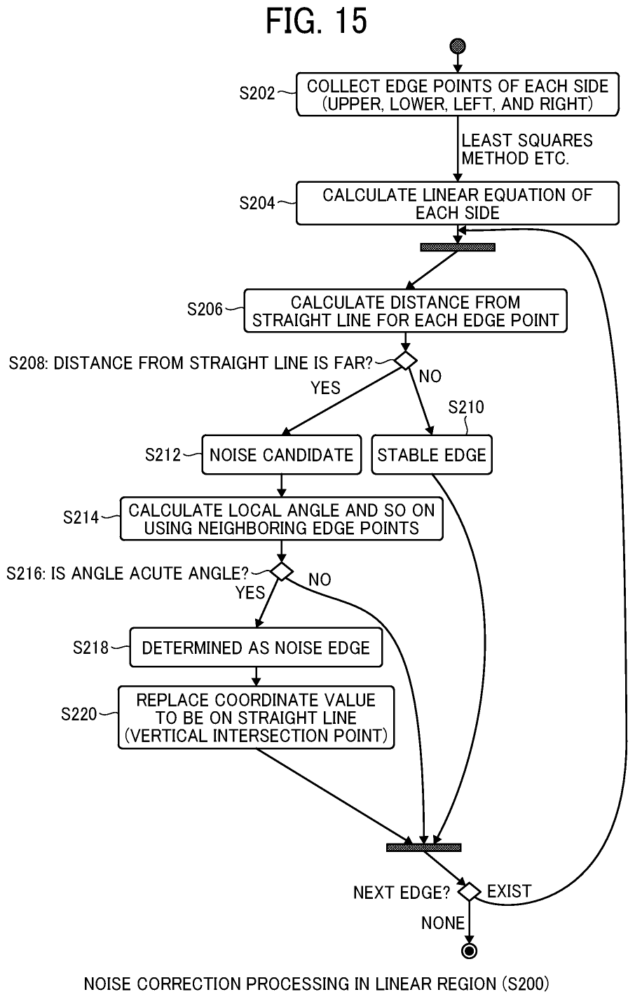

In step 20 (S20), the noise correction unit 304 (FIG. 6) corrects the position of the end point identified by the end point identification unit 302. Details are described below with reference to FIGS. 15 to 19.

In step 115 (S115), the outer edge determination unit 306 connects the end points identified by the end point identification unit 302 or the end points corrected by the noise correction unit 304 to determine the outer edge of the document in the scan image.

In step 120 (S120), the background color selection unit 310 (FIG. 5) selects a background color associated with the output destination of the image data by the file output unit 330 with reference to the table illustrated in FIG. 8.

In step 125 (S125), the filling unit 320 cuts out the image of the document region from the scan image according to the outer edge of the document determined by the outer edge determination unit 306, superimposes the image of the cut-out document region on the background image of the background color selected by the background color selection unit 310, and generates an image in which the outside of the document is filled with a predetermined background color.

In step 130 (S130), the file output unit 330 outputs the image data in which the outside of the document is filled by the filling unit 320 to a predetermined output destination.

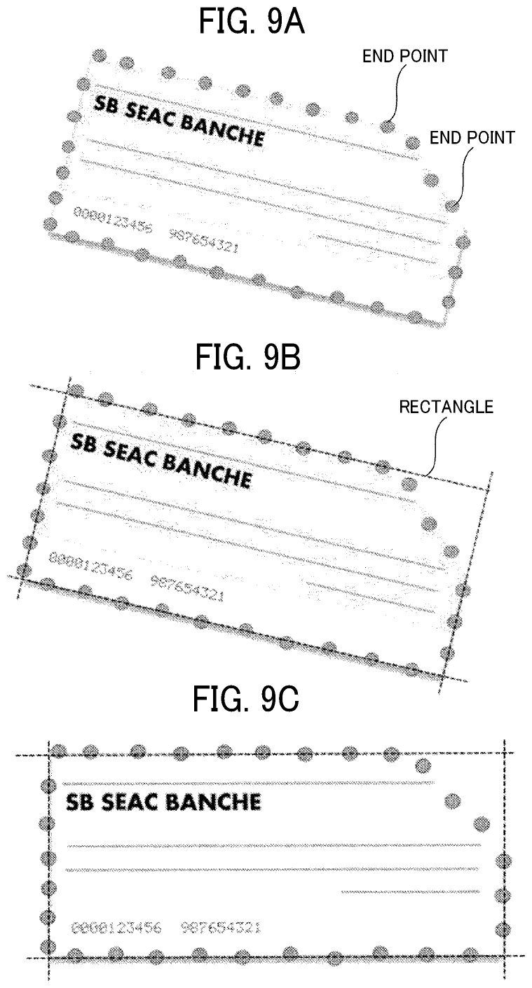

FIG. 9A, FIG. 9B, and FIG. 9C are diagrams for explaining the processing of the end point identification unit 302.

As illustrated in FIG. 9A, the end point identification unit 302 detects the boundary position (a plurality of end points) between the document and the scanner background (backing) based on the amount of change in gradation. Further, as illustrated in FIG. 9B, the end point identification unit 302 performs approximation from the end points (sampling points of the document edge) of the document with a group of likely straight lines by Hough transform or the like, and calculates and determines a rectangle (four straight lines) of the document. The end point identification unit 302 cuts out the image with the determined four straight lines, and performs skew correction as illustrated in FIG. 9C. At this time, a margin of a predetermined size may be left outside the cut-out image.

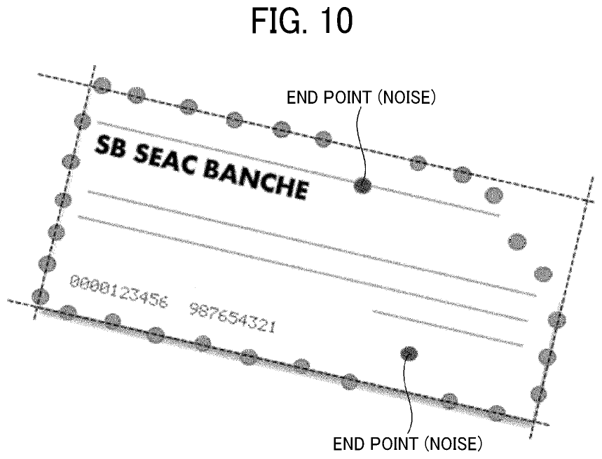

FIG. 10 is a diagram illustrating noises at the end points identified by the end point identification unit 302.

As illustrated in FIG. 10, the end points (sampling points of the document edge) identified by the end point identification unit 302 include noise samples due to an adverse effect such as a boundary detection accuracy.

Since these noises become a factor of image quality degradation in the filling process by the filling unit 320, these noises are removed.

More specifically, the noise correction unit 304 sets an end point that is away from the straight line (dotted line) of FIG. 10 by a predetermined distance or more and that has both neighboring end points in the vicinity of the straight line as a noise to be corrected.

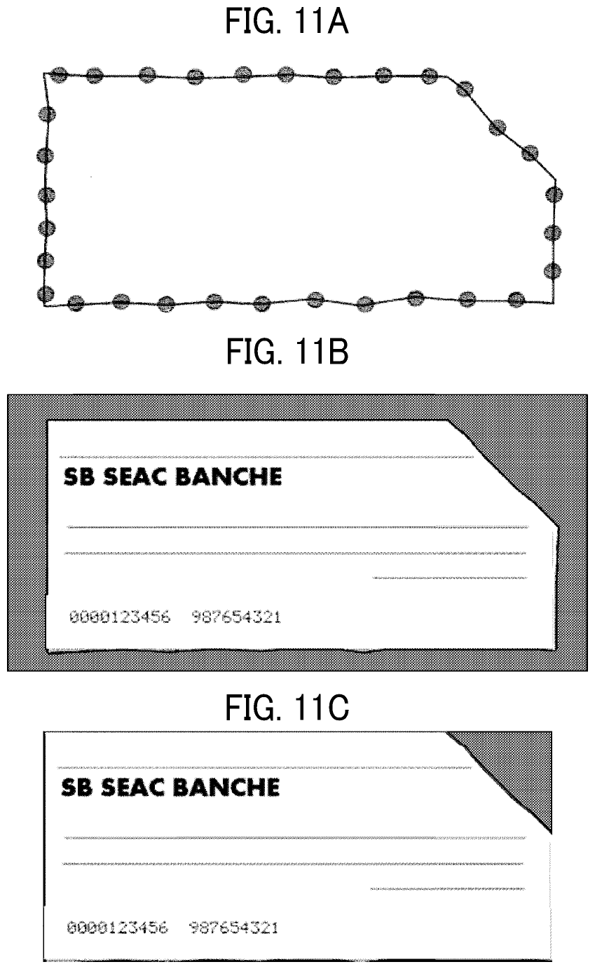

FIG. 11A, FIG. 11B, and FIG. 11C are diagrams for explaining the processing of the filling unit 320.

As illustrated in FIG. 11A, the outer edge determination unit 306 connects the end points identified by the end point identification unit 302 or the end points corrected by the noise correction unit 304 with a straight line to determine the outer edge (outer periphery) of the document.

As illustrated in FIG. 11B, the filling unit 320 fills the outside from the outer edge determined by the outer edge determination unit 306 with a predetermined color (the color selected by the background color selection unit 310). Further, the filling unit 320 cuts the document region in a rectangular shape (cuts the outside margin) to obtain the output image data of FIG. 11C. As illustrated in FIG. 11C, even when the backing of the scanner apparatus 4 is white, the output image data is an image in which the background color is changed to black and the color of a damaged part such as tearing is changed.

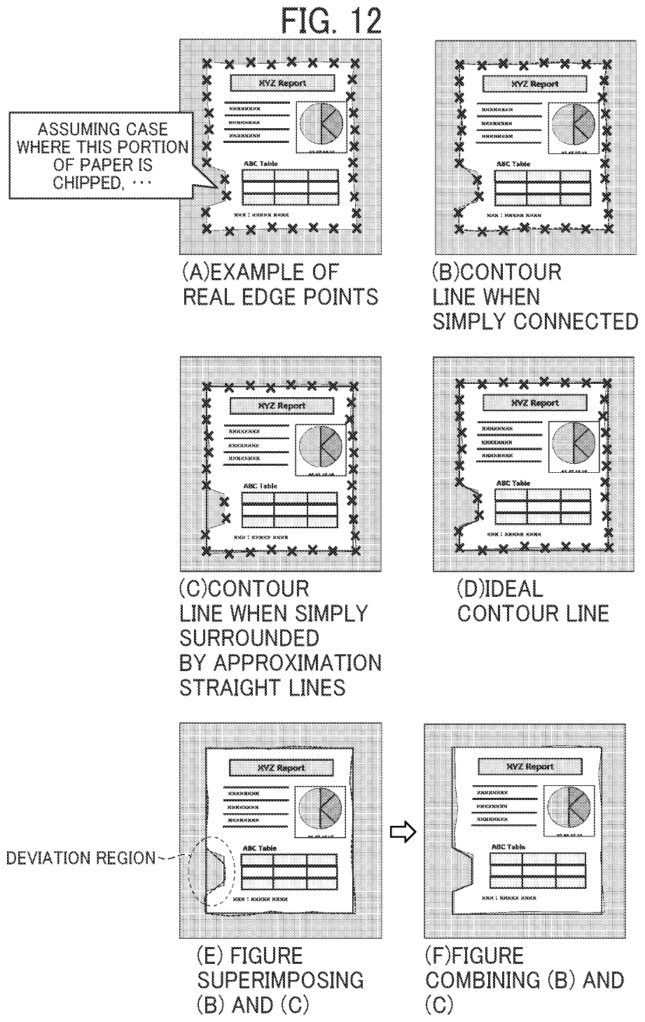

FIG. 12 is a diagram illustrating detection results of the document ends and problems thereof.

At the time of scanning by the scanner apparatus 4, the physical shaking of the document due to the document conveyance, and the light source and reflection also blur, so that the edge detection (end point identification) by the end point identification unit 302 cannot always be performed with high accuracy, and the edge detection varies within a certain range. This phenomenon is particularly noticeable when the backing is white. In a case where the backing is black and the paper of the document is white, or vice versa, the gradation difference is very large, so that accurate edge detection is expected.

For example, edge points (end points) with respect to an actual document often includes blurs as illustrated in part (A) of FIG. 12. Here, it is desired to scan the outline of the document using these edge points (end points), but when the edge points are simply connected as illustrated in part (B) of FIG. 12, the document ends fluctuate finely, and even if an actual chip can be reflected, the original document shape is not linear, and the contour line tends to be distorted more than the actual document.

Further, in the case of simply following the approximation straight line as in general cropping, as illustrated in part (C) of FIG. 12, although the shape of the document is, of course, followed, the actual chip actually is tended to be ignored.

In the present embodiment, the contour line having a shape illustrated in part (D) of FIG. 12, which has the advantages illustrated in parts (B) and (C) of FIG. 12, is needed.

The outer edge identification unit 300 of this example superimposes parts (B) and (C) of FIG. 12, and searches for a region where there is a “predetermined or greater” deviation (the deviation region of part (E) of FIG. 12). The outer edge identification unit 300 determines the outer edge of part (F) of FIG. 12, which is close to part (D) of FIG. 12, by adopting part (B) of FIG. 12 for the deviation region and adopting part (C) of FIG. 12 for the other regions.

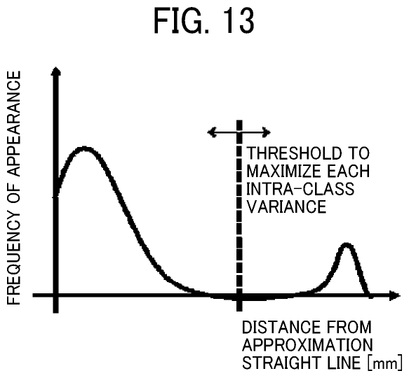

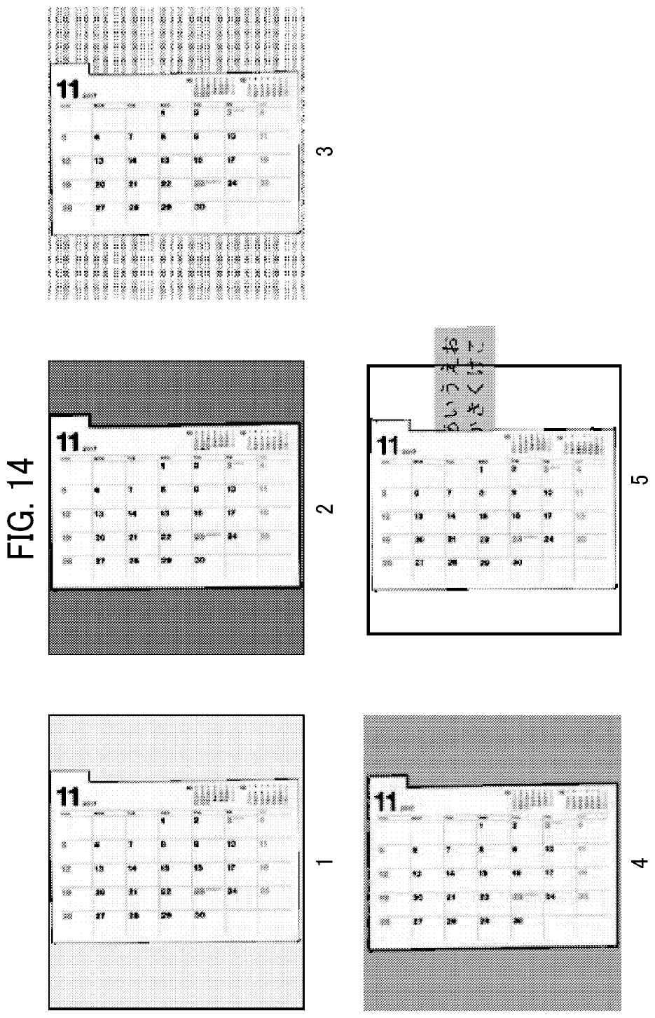

A fixed value (e.g., 2 mm) may be used as the threshold value of “whether there is a predetermined or greater deviation”, or all the deviation values in parts (B) and (C) of FIG. 12 may be collected and dynamically obtained by a discriminant analysis method. The dynamic discriminant analysis method is performed, for example, by setting a threshold value based on the frequency of appearance of the deviation value illustrated in FIG. 13 and comparing with the threshold value.

FIG. 14 is a diagram illustrating variations of the background region filled by the filling unit 320.

The filling unit 320 of this example fills the background region with black when the backing of the scanner apparatus 4 is white, but is not limited to this, and for example, as Variation 1, the portion corresponding to the backing may be dynamically switched in accordance with the background color of the document. Specifically, the filling unit 320 is filled with a color far from the background color (black background for white paper, white background for black paper) or a color close to the background color (white background for white paper, red background for red paper).

The filling unit 320 may fill with a very specific color such as red as Variation 2, or may make a background image with a pattern such as a dot as Variation 3.

Further, the filling unit 320 may display the contour line of the document as Variation 4 to support the visual confirmation by the user, or may have a transmission (alpha channel or the like) attribute as Variation 5.

Next, the noise correction processing (S20) of FIG. 7 will be described in more detail. The noise correction processing (S20) includes a noise correction processing (S200) in a linear region and a noise correction processing (S240) in a non-linear region (torn portion or the like).

First, the noise correction processing (S200) in the linear region will be described.

FIG. 15 is a flowchart for explaining the noise correction processing (S200) in the linear region.

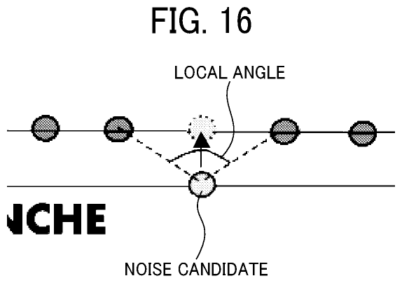

FIG. 16 is a diagram illustrating a local angle formed by three adjacent end points.

As illustrated in FIG. 15, the noise correction unit 304 (FIG. 6) collects edge points (end points identified by the end point identification unit 302) in the linear region (upper, lower, left, and right sides) (S202), and calculates a linear equation of each side based on the collected edge points (end points) by the Hough transform or the least squares method (S204).

Next, the noise correction unit 304 calculates the distance from the straight line for each edge point (S206), and determines whether the calculated distance is greater than a reference value (S208).

When the calculated distance is equal to or less than the reference value (S208: No), the noise correction unit 304 sets the edge point (end point) as a stable edge (S210), and when the calculated distance is farther than the reference value (S208: Yes), the noise correction unit 304 sets the edge point (end point) as a noise candidate (S212).

As illustrated in FIG. 16, the noise correction unit 304 calculates a local angle formed by the edge point of the noise candidate and both neighboring edge points thereof (S214), and determines whether the calculated local angle is smaller than a reference angle (S216).

When the calculated local angle is smaller than the reference angle (S216: Yes), the noise correction unit 304 sets the edge point of this noise candidate as a noise edge (S218), and when the calculated local angle is equal to or larger than the reference angle (S216: No), the noise correction unit 304 removes the edge point from the noise candidate and proceeds to the processing of the next edge point.

The noise correction unit 304 replaces the coordinate value of the edge point as the noise edge with the coordinate value of a point (vertical intersection point) on the straight line (S220). In this example, the coordinate values are replaced with the coordinate values of the points on the straight line, but the edge points that have become noise edges may be simply deleted.

The noise correction unit 304 performs the above processing for each edge point.

Next, the noise correction processing (S240) in the non-linear region (torn portion or the like) will be described. The non-linear region is a region corresponding to a corner of the document or folding or tearing in the middle of a side, and since jaggies are likely to occur, smoothing of coordinate values is performed as correction processing.

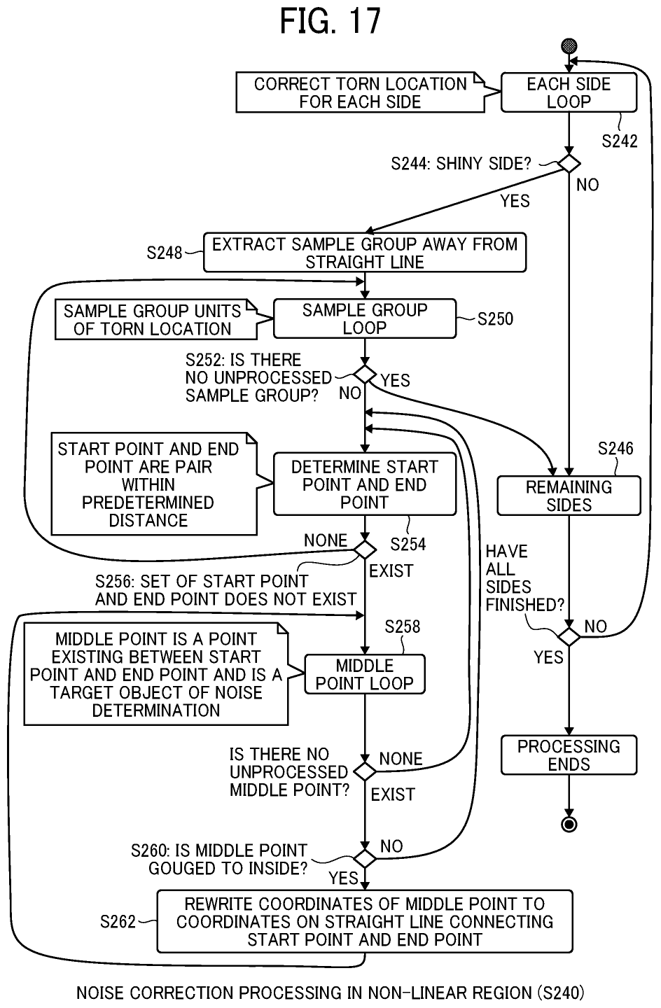

FIG. 17 is a flowchart for explaining the noise correction processing (S240) in the non-linear region.

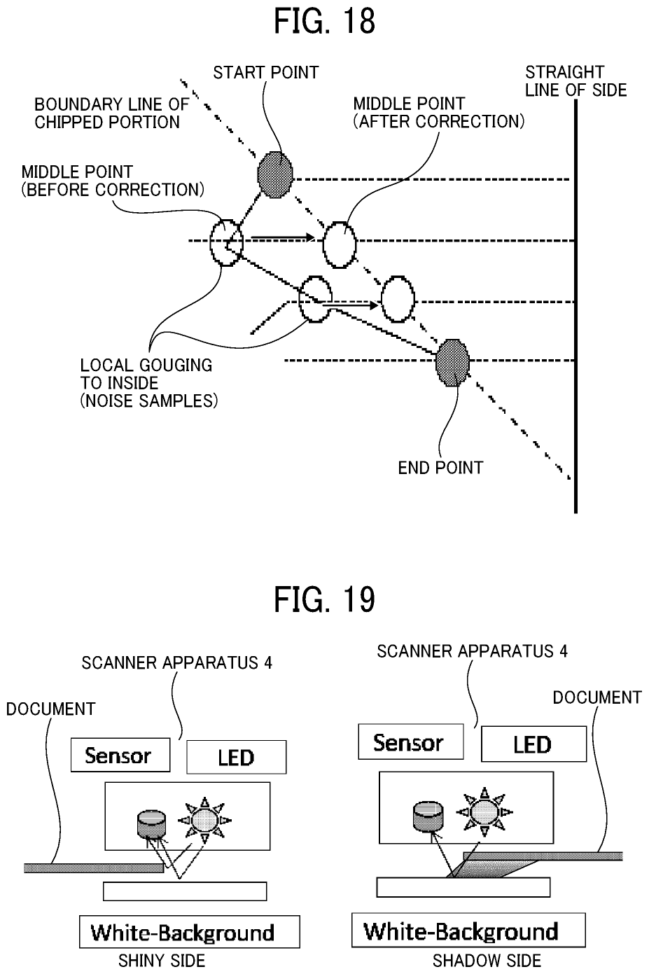

FIG. 18 is a diagram illustrating a local gouging, and FIG. 19 is a diagram for explaining a shiny side and a shadow side.

As illustrated in FIG. 17, the noise correction unit 304 (FIG. 6) performs loop processing for each side of the document (S242). The noise correction unit 304 determines whether each side is a shiny side (S244), and when the noise correction unit 304 determines that a side is not a shiny side (S244: No), the noise correction unit 304 proceeds to the processing of the remaining sides (S246), and when the noise correction unit 304 determines that a side is a shiny side (S244: Yes), the noise correction unit 304 performs the processing of S248 and subsequent steps. Here, as illustrated in FIG. 19, the shiny side is a side where the shadow of the document end is not seen from the optical sensor of the scanner apparatus 4, and the shadow side is a side where the shadow of the document end is seen from the optical sensor of the scanner apparatus 4. Whether a side of the document is a shiny side or a shadow side is determined by the positional relationship among the light source of the scanner apparatus 4, the optical sensor, and the document. That is, which of the four sides of the document is the shiny side is set in advance for each model of the scanner apparatus 4. Note that it may be determined whether a side of the document is a shiny side based on the degree of variation of the end points (edge points) in the linear region.

When the processing target is a shiny side, the noise correction unit 304 extracts a group of samples that are away from the straight line (S248). The sample group includes end points (edge points) away from the straight line, and is a group of a plurality of continuous end points existing at positions close to each other.

The noise correction unit 304 performs loop processing for each of the extracted sample groups (S250). That is, when there is no unprocessed sample group (S252: Yes), the noise correction unit 304 exits the loop processing, and when there is an unprocessed sample group (S252: No), the noise correction unit 304 performs the processing of S254 and subsequent steps.

The noise correction unit 304 determines a start point and an end point from the sample group to be processed (S254).

The noise correction unit 304 determines whether a set of a start point and an end point exists (S256), and when the set of the start point and the end point does not exist, the noise correction unit 304 proceeds to the processing of S250, and when the set of the start point and the end point exists, the noise correction unit 304 proceeds to the processing of S258.

The noise correction unit 304 performs loop processing on middle points which are end points existing between the start point and the end point so as to smooth the coordinate values between the start point and the end point (S258). That is, the noise correction unit 304 determines whether each middle point is gouged to the inside of document (S260), and for the middle point which is gouged to the inside, rewrites the coordinates of the middle point to the coordinates on the straight line connecting the start point and the end point as illustrated in FIG. 18 (S262). The gouging in this example is a state in which an end point (edge point) existing between a start point and an end point enters the inside of the document by a reference amount or more from a straight line connecting the start point and the end point. The determination of whether there is a gouging is made, for example, by determining whether the angle of the line segment formed by the three points of the start point, the middle point, and the end point is equal to or less than the reference angle.

The noise correction unit 304 may be configured to add another side (another side on the side where the shadow is not seen) as a shiny side based on the degree of the skew angle in the calculation of the four-sided rectangular straight line (when the skew angle is large). Further, the noise correction unit 304 may add a partial edge on the side where the shadow is not seen as a shiny area based on the tearing condition of the torn portion.

As described above, according to the image processing apparatus 2 of the present embodiment, image data with an appropriate background color can be obtained without being restricted by the color of the backing of the scanner apparatus 4. For example, the extraction accuracy of the white document edge in the white backing is improved. Therefore, the outer shape of the document can be accurately extracted as a non-rectangular outer shape, and the chipping and tearing of the document can be faithfully reproduced.

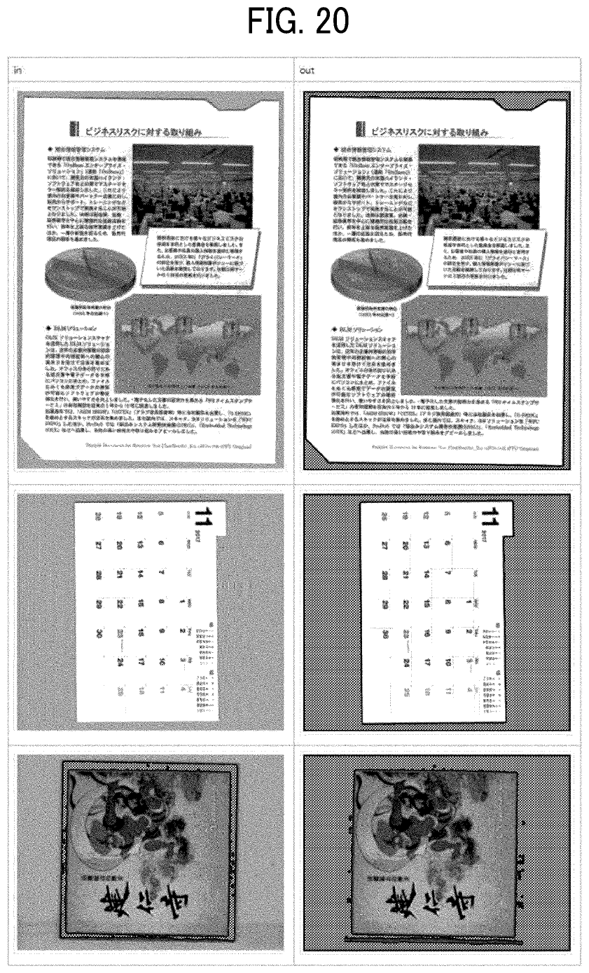

In addition, the color outside the document can be freely replaced according to the purpose (application, etc.), and image processing suitable for the characteristics of the post-stage application, such as authenticity determination, can be performed. For example, as can be seen by comparing the scan image of the scanner apparatus 4 (the left side in FIG. 20) with the image filled with a black background (the right side in FIG. 20) as illustrated in FIG. 20, a chipped or folded portion of the document can be made more conspicuous, and an error is less likely to occur in the post-stage processing.

Furthermore, even if the hardware of the scanner apparatus 4 has a low-cost configuration with only a white backing, a black backing can be realized, and a cost effect can be expected.

In addition, since a defective portion such as the chipping and tearing of the rectangular document can be extracted faithfully, it is possible to repair (color coating) the defective portion. The contour of a document can be extracted even from a non-rectangular document (e.g., a round document).

The contour of a document can be extracted faithfully even if there are unstable factors such as a variation in the gradation of the backing due to shine or thick paper.

Although the embodiments of the present disclosure have been described, the above embodiments are presented as examples and are not intended to limit the scope of the present disclosure. The above embodiments can be implemented in various other forms, and various omissions, substitutions, and changes can be made without departing from the spirit of the present disclosure. The above-described embodiments and variations thereof are intended to fall within the scope of the claimed invention and its equivalents, as well as within the scope and spirit of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image processing apparatus, comprising:
processing circuitry configured to:
identify an outer edge of a document with respect to image data optically read from the document; and
fill an outside from the outer edge in the image data with a predetermined color.

2. The image processing apparatus according to claim 1,
wherein the processing circuitry is configured to fill the outside from the outer edge with the predetermined color different from a background color of the document used when the image data is optically read.

3. The image processing apparatus according to claim 2,
wherein the processing circuitry is configured to fill the outside from the outer edge with the predetermined color associated with software that transfers the image data.

4. The image processing apparatus according to claim 3,
wherein the processing circuitry is configured to identify positions of a plurality of end points constituting ends of the document based on a gradation change in the image data, connect the plurality of end points, and determine the outer edge of the document.

5. The image processing apparatus according to claim 4,
wherein the processing circuitry is configured to correct a position of one end point based on other end points existing in a vicinity of the one end point, and determine the outer edge of the document based on the corrected position of the one end point.

6. The image processing apparatus according to claim 5,
wherein the processing circuitry is configured to perform correction processing according to which side of the document the plurality of end points correspond to.

7. An image processing method comprising:
identifying an outer edge of a document with respect to image data optically read from the document; and
filling, with a predetermined color, an outside from the outer edge identified by the identifying in the image data.

8. A non-transitory computer-executable medium storing a plurality of instructions which, when executed by a processor, causes the processor to perform:
identifying an outer edge of a document with respect to image data optically read from the document; and
filling, with a predetermined color, an outside of the outer edge identified by the identifying in the image data.
